(19) United States
(12) Patent Application Publication
(10) Pub. No.: US 2016/0294991 A1
(43) Pub. Date: Oct. 6, 2016

(54) Method And Apparatus For Providing Signaling Protocol Overload Control

(71) Applicants: Alcatel-Lucent USA Inc., Murray Hill, NJ (US); Alcatel-Lucent Deutschland AG, Stuttgart (DE)

(72) Inventors: Katherine H. Guo, Scotch Plains, NJ (US); Volker Friedrich Hilt, Waiblingen (DE)

(73) Assignees: Alcatel-Lucent USA Inc., Murray Hill, NJ (US); Alcatel-Lucent Deutschland AG, Stuttgart (DE)

(21) Appl. No.: 14/672,533

(22) Filed: Mar. 30, 2015

(51) Int. Cl. H04L 29/14; H04L 29/06

(52) U.S. Cl. CPC H04L 69/40; H04L 65/1006; H04L 65/105

(57) ABSTRACT

Various embodiments provide a method and apparatus providing signaling protocol overload control by enhancing hop-by-hop overload control using cooperation between an “upstream server” or Sending Entity (SE) and the server receiving the signaling request messages and replying with signaling reply messages for a session the “downstream server” or Receiving Entity (RE). In particular, an overload control mechanism for a signaling request transmitted between an SE and the RE allows the RE to receive from the SE a predicted load based on the original un-throttled signaling load information at the SE. The RE may then base decisions such as an overload trigger or a resource scaling decision based on the received un-throttled predicted load at the SE.

### TECHNICAL FIELD

The invention relates generally to methods and apparatus for providing signaling protocol overload control.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

In some known SIP overload control schemes, a hop-to-hop overload control mechanisms is implemented between a pair of SIP (proxy) servers for a SIP request, the upstream SIP server and the downstream SIP server. In general, hop-by-hop overload control allocates a separate control loop between all neighboring pair of SIP servers that directly exchange traffic. In general, when the predicted load during the next time step exceeds a given threshold value, SIP overload control enables the receiving entity (RE) to inform the sending entity (SE) to reduce the number of SIP sessions.

### SUMMARY OF ILLUSTRATIVE EMBODIMENTS

Some simplifications may be made in the following summary, which is intended to highlight and introduce some aspects of the various exemplary embodiments, but such simplifications are not intended to limit the scope of the inventions. Detailed descriptions of a preferred exemplary embodiment adequate to allow those of ordinary skill in the art to make and use the inventive concepts will follow in later sections

Various embodiments provide a method and apparatus providing signaling protocol overload control by enhancing hop-by-hop overload control using cooperation between an “upstream server” or Sending Entity (SE) and the server receiving the signaling request messages and replying with signaling reply messages for a session the “downstream server” or Receiving Entity (RE). In particular, an overload control mechanism for a signaling request transmitted between an SE and the RE allows the RE to receive from the SE a predicted load based on the original un-throttled signaling load information at the SE. The RE may then base decisions such as an overload trigger or a resource scaling decision based on the received un-throttled predicted load at the SE.

In a first embodiment, an apparatus is provided for providing signaling protocol overload control. The apparatus includes a data storage and a processor communicatively connected to the data storage. The processor is programmed to: monitor a local load over one or more time periods; determine a predicted local load based on the local load; receive a signaling message from an upstream server; determine a predicted remote load based on the signaling message, wherein the predicted remote load is associated with an un-throttled load of signaling messages directed from the upstream server to the apparatus; and determine a predicted load based on the predicted local load and the predicted remote load.

In a second embodiment, a method is provided for providing signaling protocol overload control. The method includes: monitoring a local load over one or more time periods; determining a predicted local load based on the local load; receiving a signaling message from an upstream server; determining a predicted remote load based on the signaling message, wherein the predicted remote load is associated with an un-throttled load of signaling messages directed from the upstream server to the apparatus; and determining a predicted load based on the predicted local load and the predicted remote load.

In a third embodiment, a non-transitory computer-readable storage medium is provided for storing instructions which, when executed by a computer, cause the computer to perform a method. The method includes: The method includes: monitoring a local load over one or more time periods; determining a predicted local load based on the local load; receiving a signaling message from an upstream server; determining a predicted remote load based on the signaling message, wherein the predicted remote load is associated with an un-throttled load of signaling messages directed from the upstream server to the apparatus; and determining a predicted load based on the predicted local load and the predicted remote load.

In some of the above embodiments, the signaling message is a SIP message.

In some of the above embodiments, the signaling message comprises a remote load parameter indicating the predicted remote load and a remote load time period parameter indicating a time period associated with the predicted remote load. In some of the above embodiments, the local load comprises a session load.

In some of the above embodiments, the determination of the predicted load is further based on a trust parameter.

In some of the above embodiments, the trust parameter is based on an historical event.

In some of the above embodiments, the remote time period parameter comprises an indication of a measurement start time; and the trust parameter is further based on a time difference between the measurement start time and a current timestamp of the apparatus.

In some of the above embodiments, the signaling message comprises a remote load parameter indicating the predicted remote load and a remote load time period parameter indicating a time period associated with the predicted remote load; and the trust parameter is based on the remote load time period parameter.

In some of the above embodiments, the local resource is an application level load metric.

In some of the above embodiments, the processor is further programmed to or the method further comprises: receive a second signaling message from a second upstream server; and determine a second predicted remote load based on the second signaling message, wherein the second predicted remote load is associated with an un-throttled second load of signaling messages directed from the second upstream server to the apparatus. Where the determination of the predicted load is further based on the second predicted remote load.

In some of the above embodiments, the processor is further programmed to or the method further comprises: determine a local load threshold; and trigger an overload control event based on the predicted load and the local load threshold.

In some of the above embodiments, the processor is further programmed to or the method further comprises: convert the predicted load to a CPU utilization load.

In some of the above embodiments, the processor is further programmed to or the method further comprises: determine a local resource threshold; mapping the predicted load to a predicted resource usage; and trigger a scaling operation based on the predicted resource usage and the local resource threshold.

In some of the above embodiments, the processor is further programmed to or the method further comprises: update the local resource threshold based on the scaling operation.

### BRIEF DESCRIPTION OF THE DRAWINGS

Various embodiments are illustrated in the accompanying drawings, in which:

FIG. 1 illustrates a network that includes an embodiment of a system 100 for providing signaling protocol overload control;

FIG. 2 illustrates an embodiment of an apparatus for a SIP server (e.g., one of SIP servers 130 of FIG. 1);

FIG. 3 depicts a first block diagram of an exemplary system 300 for providing signaling protocol overload control;

FIG. 4 depicts a second block diagram of an exemplary system 400 for providing signaling protocol overload control;

FIG. 5 depicts a flow chart illustrating an embodiment of a method 500 for an RE (e.g., one of SIP servers 130 of FIG. 1, one of SIP servers 330 of FIG. 3 or one of SIP servers 430 of FIG. 4) to provide signaling protocol overload control;

FIG. 6 depicts a flow chart illustrating an embodiment of a method 600 for an RE (e.g., one of SIP servers 130 of FIG. 1, one of SIP servers 330 of FIG. 3 or one of SIP servers 430 of FIG. 4) to determine a predicted un-throttled load from a message received from an SE (e.g., a SIP server acting as an SE to the RE) (e.g., such as the Load_{SEU} value determined from the message received in step 530 of FIG. 5);

FIG. 7 depicts a flow chart illustrating an embodiment of a method 700 for an RE (e.g., one of SIP servers 130 of FIG. 1, one of SIP servers 330 of FIG. 3 or one of SIP servers 430 of FIG. 4) to trigger an overload condition;

FIG. 8 depicts a flow chart illustrating an embodiment of a method 800 for an RE (e.g., one of SIP servers 130 of FIG. 1, one of SIP servers 330 of FIG. 3 or one of SIP servers 430 of FIG. 4) to trigger a scaling operation; and

FIG. 9 schematically illustrates an embodiment of an apparatus 900 such an SE or RE (e.g., one of SIP servers 130 of FIG. 1, one of SIP servers 330 of FIG. 3 or one of SIP servers 430 of FIG. 4).

To facilitate understanding, identical reference numerals have been used to designate elements having substantially the same or similar structure or substantially the same or similar function.

### DETAILED DESCRIPTION OF ILLUSTRATIVE EMBODIMENTS

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

Various embodiments provide a method and apparatus providing signaling protocol overload control by enhancing hop-by-hop overload control using cooperation between an “upstream server” or Sending Entity (SE) and the server receiving the signaling request messages and replying with signaling reply messages for a session the “downstream server” or Receiving Entity (RE). In particular, an overload control mechanism for a signaling request transmitted between an SE and the RE allows the RE to receive from the SE a predicted load based on the original un-throttled signaling load information at the SE. The RE may then base decisions such as an overload trigger or a resource scaling decision based on the received un-throttled predicted load at the SE.

Advantageously, providing the original un-throttled load information at the SE to the RE improves the RE's prediction on load and improves existing overload control mechanisms by increasing the number of messages processed.

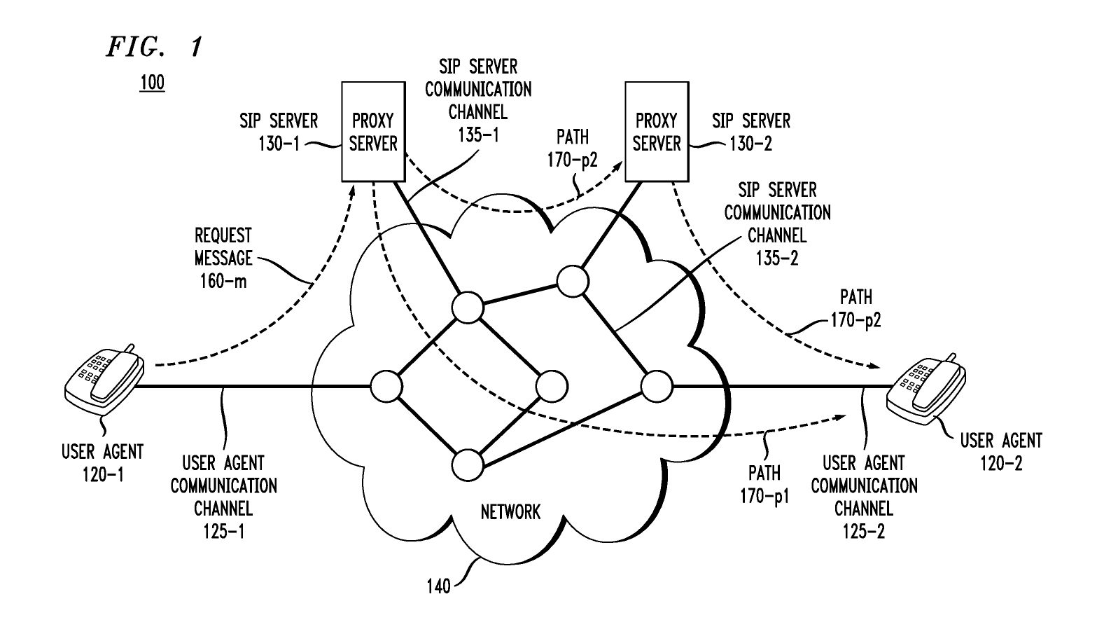

FIG. 1 illustrates a network that includes an embodiment of a system 100 for providing signaling protocol overload control. The system 100 includes two user agents 120-1 and 120-2 (collectively, user agents 120) and two SIP servers 130-1 and 130-2 (collectively, SIP servers 130). A respective one of the user agents 120 or SIP servers 130 may communicate via a communication path including appropriate ones of user agent communication channels 125-1 and 125-2 (collectively, user agent communication channels 125), SIP server communication channels 135-1 and 135-2 (collectively, SIP server communication channels 135) and network 140.

As an example of establishing a communication connection, FIG. 1 illustrates how SIP server 130-1 is responsible for establishing communication connections between user agent 120-1 and 120-2. In this example, when SIP server 130-1 receives request message 160-m from user agent 120-1 inviting user agent 120-2 to join a session, SIP server 130-1 forwards this invitation to user agent 120-2 directly (e.g., path 170-p1) or through one or more other SIP servers (e.g., via SIP server 130-2 over path 170-p2).

It should be appreciated that although depicted as using the SIP protocol and SIP servers herein, the signaling protocol may be any suitable signaling protocol and the SIP servers may be any servers supporting the signaling protocol.

User agents 120 may include any type of communication device(s) capable of sending or receiving signaling messages over network 140 via one or more of user agent communication channels 125. In particular, User agents are the endpoints of a communication session. For example, a communication device may be a thin user agent, a smart phone (e.g., user agent 120-n), a personal or laptop computer (e.g., user agent 120-1), server, network device, tablet, television set-top box, media player or the like. Communication devices may rely on other resources within exemplary system to perform a portion of tasks, such as processing or storage, or may be capable of independently performing tasks. It should be appreciated that while two user agents are illustrated here, system 100 may include more user agents. Moreover, the number of user agents at any one time may be dynamic as user agents may be added or subtracted from the system at various times during operation.

In some embodiments, a user agent includes two components: a client and a server. The user agent making a request (such as initiating a session), is a User Agent Client (UAC), and the user agent responding to the request is the User Agent Server (UAS). Because a user agent will send a message, and then respond to another, a use agent may switch back and forth between client and server roles throughout a session.

The communication channels 125 and 135 support communicating over one or more communication channels such as: wireless communications (e.g., LTE, GSM, CDMA, Bluetooth); WLAN communications (e.g., WiFi); packet network communications (e.g., IP); broadband communications (e.g., DOCSIS and DSL); storage communications (e.g., Fibre Channel, iSCSI), and the like. It should be appreciated that though depicted as a single connection, communication channels 125 and 135 may be any number or combinations of communication channels.

SIP servers 130 may be any apparatus capable of sending or receiving signaling messages over network 140 via one or more of SIP communication channels 135 and providing signaling protocol overload control using cooperation between an SE (e.g., SIP server 130-1) and an RE (e.g., SIP server 130-2). In particular, the SE monitors its current un-throttled load over a period of time, determines a predicted remote load based on the monitored load and transmits the predicted remote load to the RE. The RE monitors its current local load over a period of time predicts its local load, receives the predicted remote load from the SE, and triggers overload control or a resource scaling decision based on the predicted local load and the received predicted remote load. For example, based on the predicted local load and the received predicted remote load, the RE may inform the SE to reduce the number of SIP INVITE messages to avoid an overload condition at the RE or the RE may scale up resources or start a new VM in order to enable the RE to handle more messages.

It should be appreciated that while only two SIP servers are illustrated here, system 100 may include more SIP servers.

The network 140 includes any number of access and edge nodes and network devices and any number and configuration of links. Moreover, it should be appreciated that network 140 may include any combination and any number of wireless, or wire line networks including: LTE, GSM, CDMA, Local Area Network(s) (LAN), Wireless Local Area Network(s) (WLAN), Wide Area Network (WAN), Metropolitan Area Network (MAN), or the like.

In some embodiments of the system 100, the signaling protocol is the Session Initiation Protocol (SIP). In some of these embodiments, SIP is used for session management in a 3GPP/3GPP2 standard-based IP Multimedia Subsystem (IMS). In some of these embodiments, one or more of SIP servers 130 may be: a register server, a proxy server or a redirect server.

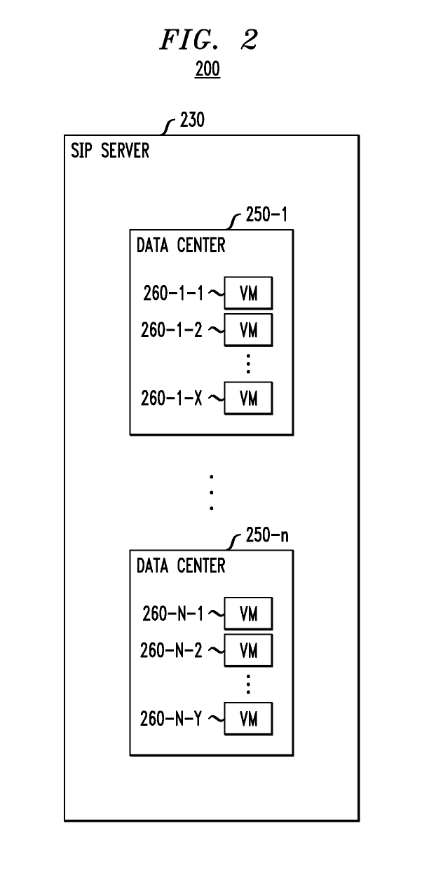

FIG. 2 illustrates an embodiment of an apparatus for a SIP server (e.g., one of SIP servers 130 of FIG. 1). SIP server 230 includes one or more virtual machines VM 260-1-1-VM 260-N-Y (virtual machines 260) in one or more data centers 250-1-250-n (collectively, data centers 250).

The data centers 250 include one or more virtual machines 260. Each of virtual machines 260 may include any types or configuration of resources and service any type or number or application instances required to perform the functions of the SIP server as described herein. Resources may be any suitable device utilized by a virtual machine such as, for example: servers, processor cores, memory devices, storage devices, networking devices or the like. In some embodiments, data centers 250 may be geographically distributed. It should be appreciated that while two data centers are illustrated here, system 200 may include fewer or more data centers.

It should be appreciated that although depicted as VMs herein, a SIP server may include any suitable configuration of resources such as, for example, containers or any other suitable resource grouping. Moreover, as used herein, a data center is construed broadly to include all hardware configurations allowing dynamic provisioning of resources (e.g., such as a single server running a cloud and virtualization software program).

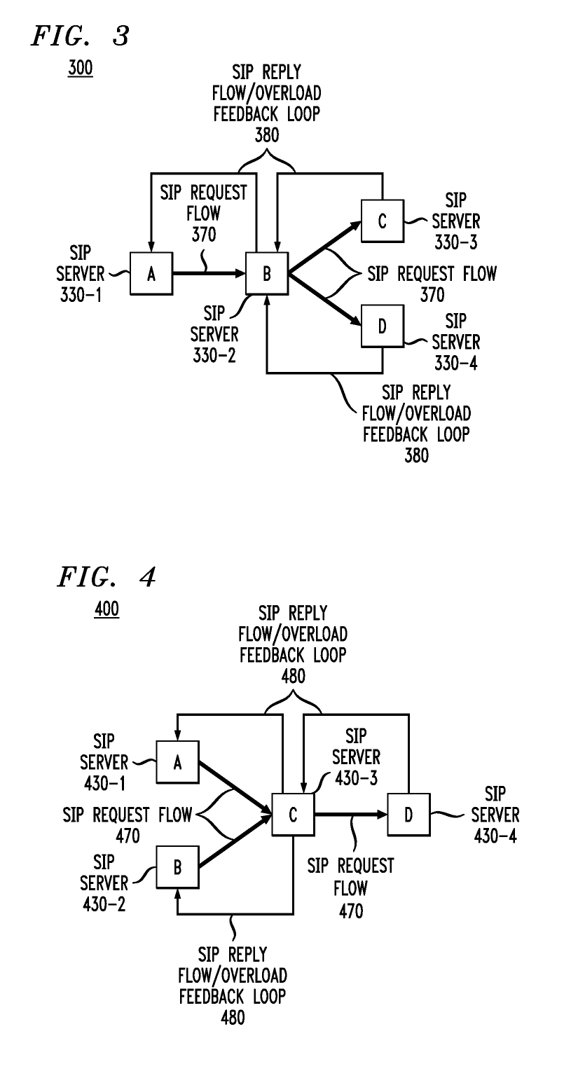

FIG. 3 depicts a first block diagram of an exemplary system 300 for providing signaling protocol overload control. System 300 includes SIP servers 330-1-330-4 (collectively, SIP servers 330) showing hop-to-hop overload control mechanisms between pairs of SIP servers 330. In this example, SIP requests flow left to right as indicated by SIP request flow 370 and the SIP reply flow and overload feedback loop flow right to left as indicated by SIP reply flow/overload feedback loop 380. In the example in FIG. 3, for the pair of SIP servers 330-1 and 330-2, SIP server 330-1 is the SE and SIP server 330-2 is the RE; for the pair of SIP servers 330-2 and 330-3, SIP server 300-2 is the SE and SIP server 330-3 is the RE; for the pair of SIP servers 330-2 and 330-4, SIP server 330-2 is the SE and SIP server 330-4 is the RE. It should be appreciated that SIP servers 330-3 and 330-4 send overload control information to SIP server 330-2 based on its prediction of load on SIP servers 330-3 and 330-4 respectively and that SIP server 330-2 reacts to overload control mechanisms from both SIP servers 330-3 and 330-4.

It should be appreciated that while only four SIP servers are illustrated here, system 100 may include more or less SIP servers.

FIG. 4 depicts a second block diagram of an exemplary system 400 for providing signaling protocol overload control. System 400 includes SIP servers 430-1-430-4 (collectively, SIP servers 430) showing hop-to-hop overload control mechanisms between pairs of SIP servers 430. In this example, SIP requests flow left to right as indicated by SIP request flow 470 and the SIP reply flow and overload feedback loop flow right to left as indicated by SIP reply flow/overload feedback loop 480. In the example in FIG. 4, for the pair of SIP servers 430-1 and 430-3, SIP server 430-1 is the SE and SIP server 430-3 is the RE; for the pair of SIP servers 430-2 and 430-3, SIP server 400-2 is the SE and SIP server 430-3 is the RE; for the pair of SIP servers 430-3 and 430-4, SIP server 430-3 is the SE and SIP server 430-4 is the RE. It should be appreciated that SIP load prediction on SIP server 430-3 may be based on the sum of un-throttled load predictions from both SEs SIP servers 430-1 and 430-2 and separate overload control instructions from SIP server 430-3 may be sent to SIP servers 430-1 and 430-2.

It should be appreciated that while only four SIP servers are illustrated here, system 100 may include more or less SIP servers.

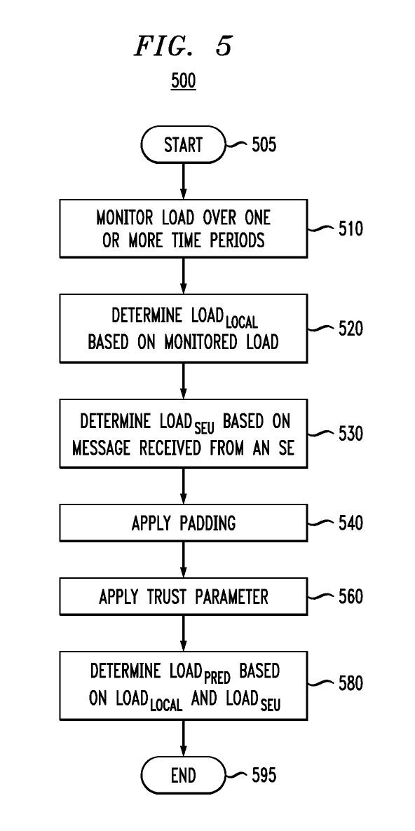

FIG. 5 depicts a flow chart illustrating an embodiment of a method 500 for an RE (e.g., one of SIP servers 130 of FIG. 1, one of SIP servers 330 of FIG. 3 or one of SIP servers 430 of FIG. 4) to provide signaling protocol overload control. The method starts at step 505 and includes: monitoring a signaling message load over one or more historic time periods (step 510); determining a predicted local load (Load_{Local}) based on the monitored signaling message load from step 510 (step 520); determining an un-throttled load at the SE (Load_{SEU}) based on a message received from the SE (e.g., a SIP server acting as an SE to the RE) (step 530); optionally applying a padding value to Load_{Local} or Load_{SEU} (step 540); optionally applying a trust parameter to Load_{SEU} (step 560); determining a predicted load for a future time period (Load_{Pred}) based on Load_{Local} and Load_{SEU} (step 580); and ending at step 595.

In the method 500, the step 510 includes an apparatus (e.g., one of SIP servers 130 of FIG. 1, one of SIP servers 330 of FIG. 3 or one of SIP servers 430 of FIG. 4) monitoring a signaling message load over one or more historic time periods. In particular, SIP overload control works in time steps where during each time step, the observed load of the RE during one or more past time steps (e.g., t−n . . . t−1) is recorded locally. Any suitable metric may be used to indicate the observed load of the RE such as, for example: (a) SIP sessions per second; (b) CPU utilization; (c) SIP message queue length; or the like. It should be appreciated that though described herein in reference to a particular metric for purposes of clarity, any suitable metric may be used.

In the method 500, the step 520 includes an apparatus (e.g., one of SIP servers 130 of FIG. 1, one of SIP servers 330 of FIG. 3 or one of SIP servers 430 of FIG. 4) determining a predicted local load (Load_{Local}) based on the monitored signaling message load from step 510. In particular, Load_{Local} (i.e., predicted Load(t)) is based on the monitored load at one or more of prior time periods t−n . . . t−1. In some embodiments, the Load_{Local}=Load(t−1). In some embodiments, Load_{Local} is based on an analysis of the monitor load occurring at more than one prior time interval. For example, conventional techniques may be used to determine a modified load that is higher or lower than the monitored load based on the characteristics of the monitored load over a number of prior time periods or a training set of data identifying usage patterns.

In the method 500, the step 530 includes an apparatus (e.g., one of SIP servers 130 of FIG. 1, one of SIP servers 330 of FIG. 3 or one of SIP servers 430 of FIG. 4) determining an un-throttled load at the SE (Load_{SEU}) based on a message received from the SE (e.g., a SIP server acting as an SE to the RE). In particular, the apparatus retrieves the Load_{SEU} from a signaling message received from the SE. It should be appreciated that the SE sending the signaling message to the RE may determine Load_{SEU} as described herein for the RE (e.g., monitoring an load and determining a predicted load in steps 510 and 520) with the caveat that the loads monitored and predicted by the SE are based on the un-throttled load and not the actual transmitted load. Moreover, it should be appreciated that when an SE connects to multiple REs, the SE may send multiple values of Load_{SEU} each with a unique SIP server as the next hop server. Refer Referring to FIG. 3, SIP server 330-2 may determine a value Load_{SEU}(C) for a message going to next hop SIP server 330-3, and a second value of Load_{SEU}(D) for a message going to next hop SIP server 330-4.

In the method 500, the step 580 includes an apparatus (e.g., one of SIP servers 130 of FIG. 1, one of SIP servers 330 of FIG. 3 or one of SIP servers 430 of FIG. 4) determining a predicted load for a future time period (Load_{Pred}) based on Load_{SEU} and optionally Load_{Local}. In particular, the RE utilizes the un-throttled SIP load information on the SE to determine a predicted load for a future time. It should be appreciated that in some embodiments, with an overload control mechanism in place, Load_{SEU}>=Load_{Local} since SIP traffic is throttled at the SE through the overload control mechanism and thus, in some embodiments, Load_{Pred} may not be based on Load_{Local}.

In a first embodiment of the step 580, when Load_{SEU} is not available (e.g., receiving a message from a non-conforming SE), Load_{Pred}=Load_{Local}.

In a second embodiment of the step 580, Load_{Pred} is based on Load_{SEU} and Load_{Local}. In some of these embodiments, Load_{Pred}=max(Load_{SEU}, Load_{Local}).

In a third embodiment of the step 580, Load_{SEU} is available but is not trusted. A Load_{SEU} might not be trusted for any suitable reason such as: the sending SE is unknown, the SE and RE belong to different service providers, the communication between the SE and RE is not secure, or the unit of Load_{SEU} is inconsistent with Load_{Local}. In some of these third embodiments, Load_{SEU} may be ignored and Load_{Pred} may be determined as in the first embodiment or Load_{SEU} may be trusted and determined as in the second environment.

In some of the third embodiments, Load_{SEU} is treated with caution (i.e., embodiment 3 (treat with caution). In these embodiments, the method 500 includes step 560. Step 560 includes applying a trust parameter to Load_{SEU}. A trust parameter may be any suitable parameter or set of parameters that take into account the integrity of the received Load_{SEU} or the sending SE. For example a trust parameter may be implemented as in the embodiments enumerated below.
1. Load_{SEU} is modified based on a parameter b; where 0<=b<=1 is a trust parameter reflecting how much trust the RE places in Load_{SEU} from the SE. For example, b*Load_{SEU} is used to represent Load_{SEU}.
2. Load_{SEU} is modified based on a parameter b and Load_{Local}. For example, Load_{Local}+b*(Load_{SEU}−Load_{Local}); where Load_{SEU}≧Load_{Local} is used to represent Load_{SEU}. It should be appreciated that by adjusting only the load difference between Load_{SEU} and Load_{Local} by the trust factor b, a more aggressive trust factor may be used. For example, in a first scenario where Load_{SEU}=10*Load_{Local} and a second scenario where Load_{SEU}=1.1*Load_{Local}, multiplying the entire value of Load_{SEU} by b might not provide the desired results in both scenarios. In the first scenario, a factor of b that is too high (i.e., close to 1) may result in predicted loads that are almost ten times the current load which may result in undesired results (e.g., triggers that are too aggressive or inefficient scaling) if the value of Load_{SEU} is indeed incorrect. In the second scenario, if the factor of b is too low (i.e., close to 0 to protect against the false large loads of scenario one), then any value of Load_{SEU} would be dampened below the value of Load_{Local} and the system would might not achieve the desired benefits as described herein.
3. Load_{SEU} is modified based on a threshold increment (i.e., Load_{ThresholdInc}) and Load_{Local}. For example, Load_{SEU} may be represented by Load_{SEU} when Load_{SEU}≦Load_{Local}+Load_{ThresholdInc} and by Load_{Local}+Load_{ThresholdInc} when Load_{SEU}>Load_{Local}+Load_{ThresholdInc}. It should be appreciated that the threshold increment may be used in any of these enumerated embodiments.
4. Load_{SEU} is modified based on an historical event/data. In particular, past events associated with prior values of Load_{SEU} received from the same SE are used to modify the trust parameters. It should be appreciated that the historical event may be used in any of these enumerated embodiments. For example, the following sequence below provides one example of modifying the trust parameters based on historical event(s).
   a. @(t−2):
      i. Load_{SEU}=10*Load_{Local} is received
      ii. Load_{SEU} is modified to equal Load_{Local}+Load_{ThresholdInc}
   b. @(t−1):
      i. Load_{Local}≧Load_{SEU}(t−2); increasing the trust level since the prior value of Load_{SEU} has been authenticated to a partial degree
      ii. Load_{SEU}=8*Load_{Local} is received
      iii. Load_{SEU} is modified to equal Load_{Local}+2*Load_{ThresholdInc}, e.g., the threshold increment Load_{ThresholdInc} has been increased (multiplied by 2) as a result of the prior increase being substantiated.

In a fourth embodiment of the step 580, the first, second and third embodiments are used based on whether Load_{SEU} is available and trusted as indicated in the table below.

| | Load_{SEU} Trusted | Load_{SEU} Not trusted |
|---|---|---|
| Load_{SEU} Available | Embodiment 2 | Embodiment 3(treat |
| | | with caution) |
| Load_{SEU} Unavailable | Embodiment 1 | Embodiment 1 |

The method 500 optionally includes step 540. Step 540 includes applying a padding value to Load_{Local} or Load_{SEU}. In particular, the padding increases the value of Load_{Local} or Load_{SEU}. The padding (Load_{Padding}) may be implemented in any suitable way such as for example:

[Load_{Local}|Load_{Pred}|Load_{SEU}]=[Load_{Local}|Load_{Pred}⊕Load_{SEU}][+|*]Load_{Padding}.

In some embodiments, Load_{Padding} is in the unit of SIP sessions per unit time. In some other embodiments, Load_{Padding} is >=1 and is a parameter to increase the value of estimated SIP load.

In some embodiments of the steps 510, the RE tracks the INVITE SIP message initiating a session, and uses the rate of SIP INVITE messages as SIP session rate.

In some embodiments of the step 530, the message received from the SE is a signaling message containing the Load_{SEU} and optionally attendant information as described herein. In some of these embodiments, the Load_{SEU} and optionally attendant information is within a SIP request messages received from the SE.

In some embodiments of the step 580, the value of Load_{Pred} at the RE is based on more than one of the Load_{SEU} values received. It should be appreciated that multiple SEs can send traffic to one RE. For example, referring to FIG. 4, SIP server 430-3 may receive Load_{SEU}(A) from SIP server 430-1 and Load_{SEU}(B) from SIP server 430-2. In some of these embodiments, Load_{SEU}=Σᵢ Load_{SEU}(i) where Load_{Pred} is then determined based on this determined sum as described herein. In some of these embodiments, Load_{Pred}=Σᵢ Load_{Pred}(i) where each selected Load_{Pred} (i) is determined based on a corresponding Load_{SEU}(i) as described herein.

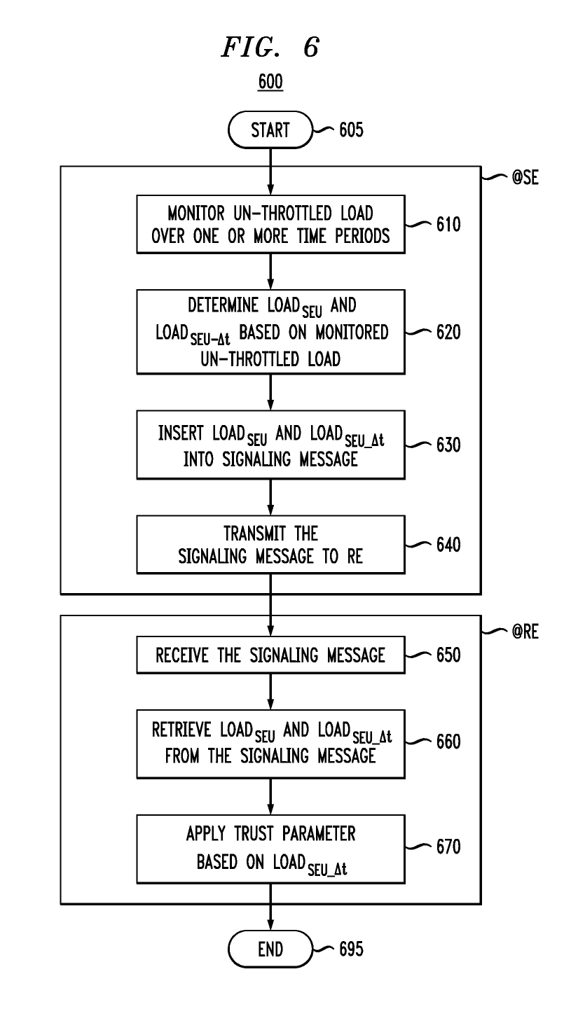

FIG. 6 depicts a flow chart illustrating an embodiment of a method 600 for an RE (e.g., one of SIP servers 130 of FIG. 1, one of SIP servers 330 of FIG. 3 or one of SIP servers 430 of FIG. 4) to determine a predicted un-throttled load from a message received from an SE (e.g., a SIP server acting as an SE to the RE) (e.g., such as the Load_{SEU} value determined from the message received in step 530 of FIG. 5). The method starts at step 605 and includes: monitoring, at the SE, the un-throttled load over one or more time periods (step 610); determining, at the SE, Load_{SEU} and Load_{SEU}_{_}_{Δt} based on the monitored un-throttled load from step 610 (step 620); inserting, at the SE, Load_{SEU} and Load_{SEU}_{_}_{Δt} into a signaling message (step 630); receiving the signaling message at the RE (step 650) and retrieving Load_{SEU} and Load_{SEU}_{_}_{Δt} from the signaling message (step 660) as embodiments of step 530 of FIG. 5; and optionally applying a trust parameter based on Load_{SEU}_{_}_{Δt} as an embodiment of step 560 of FIG. 5 (step 670); and ending at step 695.

In the method 600, the step 610 includes monitoring, at the SE, the un-throttled load over one or more time periods. It should be appreciated that the SE may monitor the un-throttled load as described herein for the RE, particularly as described in step 510 of FIG. 5.

In the method 600, the step 620 includes determining, at the SE, Load_{SEU} and Load_{SEU}_{_}_{Δt} based on the monitored un-throttled load from step 610. It should be appreciated that the SE may determine the un-throttled load, Load_{SEU}, as described herein for the value Load_{Local} of the RE, particularly as described in step 520 of FIG. 5. Load_{SEU}_{_}_{Δt} indicates the duration of the time period corresponding to the value of Load_{SEU}. It should be appreciated that the SE and the RE need to agree on the format to use for the values of Load_{SEU} and Load_{SEU}_{_}_{Δt}. For example, a unit of time such as milliseconds for which a value of Load_{SEU}_{_}_{Δt} is based.

In the method 600, the step 630 includes inserting, at the SE, Load_{SEU} and Load_{SEU}_{_}_{Δt} into a signaling message. In particular, any suitable method of inserting, appending or creating a new message(s) that indicates the values of Load_{SEU} and Load_{SEU}_{_}_{Δt} may be used. In some embodiments, a time period Load_{SEU}_{_}_{Δt} is agreed upon during an initial message, is indicated in the message tag, is embedded in the value of Load_{SEU} or by any other suitable method and thus, may not be required to be sent during every message. For example, if a time period has been agreed upon by an SE and RE pair, for example, in a previous message, subsequent messages may contain only the value Load_{SEU} In another example, if the value of Load_{SEU} is sent as a session rate (sessions over an agreed period of time), then the value of Load_{SEU} may be used to derive a session count associated with a time period. In another example, a tag such as “oc1” could signal a load value measured over a Δt of duration d1 and a tag such as “oc2” could signal a load value measured over a Δt of duration d2.

In the method 600, the step 640 includes transmitting, at the SE, the signaling message to the RE. The signaling message is transmitted using any suitable method including conventional techniques such as packet transmission.

In the method 600, the step 650 includes receiving, at the RE, the signaling message and the step 660 includes retrieving, at the RE, Load_{SEU} and Load_{SEU}_{_}_{Δt} from the signaling message as embodiments of step 530 of FIG. 5.

In step 650, the signaling message is received using any suitable method including conventional techniques such as packet transmission.

In step 660, Load_{SEU} and Load_{SEU}_{_}_{Δt} are retrieved from the signaling based how the parameters were inserted in step 630. For example, if Load_{SEU} and Load_{SEU}_{_}_{Δt} are passed in the via header of a SIP message using two tags such as “oc-offered” and “oc-offered-time”, then the RE may parse the via header for these tags and extract the values associated with these tags. The values may be passed with associated units of time or the SE and RE may use units of time agreed upon beforehand. For example, units of time may have been negotiated in a previous message, be determined by a network management tool and passed to the SE and RE or codified in a programming interface (e.g., a standard associated with SIP or a defacto industry practice).

The method 600 optionally includes step 670. Step 670 includes optionally applying a trust parameter based on Load_{SEU}_{_}_{Δt} as an embodiment of step 560 of FIG. 5. In particular, applying a trust parameter is enhanced to determine a trust factor based Load_{SEU}_{_}_{Δt} and local time parameters. In some embodiments, the trustworthiness of Load_{SEU} may be based on the start time of the measurement period at the SE from the current time step at the RE. In some embodiments, if the value of Load_{SEU} is greater than a threshold distance from the current time step at the RE, the trust parameter may be lowered. In some embodiments, the trust parameter may be adjusted based on the magnitude of difference between the start time of the measurement period at the SE from the current time step at the RE.

In some embodiments, the decision to adjust the trust parameter is based on a function such as b=f3(d) where b is the trust factor and d is the time distance between the start timestamp of the measurement period at the SE and the current timestamp at the RE and f3 is a function that translates the time distance to the trust parameter. In some of these embodiments, the function (e.g., f3) is b=e/d, where the input parameter e is set to the length of the time step used by the monitor or predictor modules on the SIP server, and where e<=d.

In some embodiments of the step 620, Load_{SEU}_{_}_{Δt} includes a start time and a length of the measurement time. In some embodiments, the start time indicates the period associated with the monitored load values from which Load_{SEU} is determined.

In some embodiments of the step 620 and 660, Load_{SEU}_{_}_{Δt} is based on a local timestamp at the SE and the RE uses the difference between the timestamp from the SE and its own timestamp to determine the combined effect of clock drifts between the SE and the RE and the time the request message spent on the network from the SE to the RE. Advantageously, using a local timestamp may decrease the overhead of the exchange between the SE and the RE on the format for the measurement start time.

In some embodiments of the step 630, the signaling message is a SIP message. In some of these embodiments, Load_{SEU} and Load_{SEU}_{_}_{Δt} are passed as parameters in the Via header. It should be appreciated that Via headers are overwritten at each SIP server the SIP message passes through, and therefore, the parameters are advantageously only exchanged between the coordinating SE and RE (e.g., one hop on the SIP message path).

In some embodiments of the step 630, the SE adds a parameter identified by a tag (e.g., “oc”) to signal to the RE that the SE supports overload control and can process the overload control parameters returned by the RE on reply messages from the RE to the SE. In some of these embodiments, the tag does not have a corresponding value.

In some embodiments of the step 630, parameters added to the signaling message are not overloaded and two or more separate tags are used to pass the values of Load_{SEU} and Load_{SEU}_{_}_{Δt}.

In some embodiments of the step 630, parameters added to the signaling message are overloaded and a single tag is used to pass the values of Load_{SEU} and Load_{SEU}_{_}_{Δt}. In some of these embodiments, if there is no value following the tag (e.g., “oc”), the message indicates support for overload control mechanisms. In some of these embodiments, if there are values following the tag, then the message indicate support for overload control mechanisms and the values associated with the tags indicates values for Load_{SEU} or Load_{SEU}_{_}_{Δt}. In some of these embodiments, when there is only one value following the tag, the value represents Load_{SEU}. In some of these embodiments, when there is more than one value following the tag, the values represent Load_{SEU} and Load_{SEU}_{_}_{Δt}.

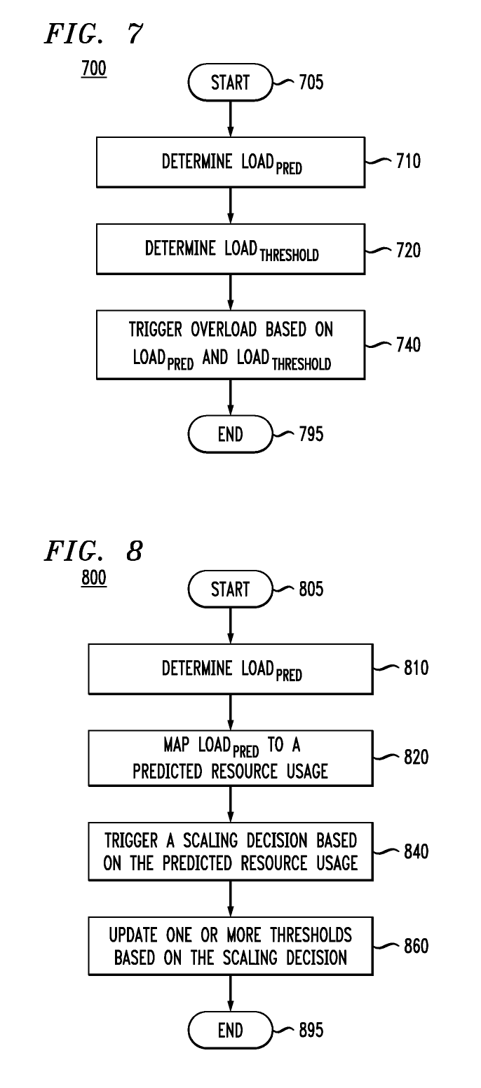

FIG. 7 depicts a flow chart illustrating an embodiment of a method 700 for an RE (e.g., one of SIP servers 130 of FIG. 1, one of SIP servers 330 of FIG. 3 or one of SIP servers 430 of FIG. 4) to trigger an overload condition. The method starts at step 705 and includes: determining, at the RE, Load_{Pred} (step 710); determining, at the RE, Load_{Threshold} (step 720); triggering, at the RE, an overload condition based on Load_{Pred} and Load_{Threshold} (step 740); and ending at step 795.

In the method 700, the step 710 includes determining, at the RE, Load_{Pred} as described herein, particularly in the steps of FIG. 5.

In the method 700, the step 720 includes determining, at the RE, a threshold load (i.e., Load_{Threshold}). Load_{Threshold} may be any suitable parameter having a relationship with Load_{Pred}. For example, Load_{Threshold} may be:

(i) the maximum SIP session rate (Load_{Threshold(R)}), or

(ii) the maximum CPU utilization (Load_{Threshold(U)}), or

(iii) the maximum SIP queue length (Load_{Threshold(Q)}).

In some embodiments, the resource limit (e.g., VM or container) is constant at the RE, providing a rough correlation between the maximum values of any one of the parameters to any of the other parameters. In some of these embodiments, the equivalent relationship between these three parameters is measured and updated at the RE advantageously allowing the RE to use only one of the parameters.

In the method 700, the step 740 includes triggering an overload condition, at the RE, based on Load_{Pred} and Load_{Threshold}. In particular, based on the relationship between Load_{Pred} and Load_{Threshold}, the RE triggers overload control. For example, a comparison that the Load_{Pred} meets or exceeds the threshold Load_{Threshold} may trigger overload control. An overload condition trigger may include any suitable event such as: sending a message to the SE (e.g., over SIP reply flow/overload feedback loop 380 of FIG. 3), activating an alert, or the like. It should be appreciated that though SIP overload mechanisms may operate at a smaller time scale, values Load_{Pred} and Load_{Threshold} may exist at any time instance.

In some embodiments of the step 740, Load_{Pred} or Load_{Threshold} is converted in order to analyze the relationship. For example, denoting CPU capacity, SIP session rate and SIP queue length by the labels U, R, and Q respectively, mapping functions may be used to convert between R [symbol] U and Q [symbol] U. For example,
1. U=f1(R)
2. U=f2(Q)
3. R=f1_inverse(U)
4. Q=f2_inverse(U)

It should be appreciated that a received un-throttled load (e.g., Load_{SEU(R)}) may be in a different form than desired for triggering overload control (e.g., Load_{Threshold(U)}).

In some embodiments of the step 720 where the threshold metric is Load_{Threshold(U)}, the RE monitors the observed CPU utilization Load_{Local(U)} and predicts CPU usage (Load_{Pred(U)}) based on the monitored CPU utilization during a number of previous time steps as described herein.

In some embodiments of the step 720, the overload trigger is based on: the predicted SIP session rate (Load_{Pred(R)}), the maximum SIP session rate (Load_{Threshold(R)}), the predicted message queue length (Load_{Pred(Q)}), the maximum message queue length (Load_{Threshold(Q)}), the predicted CPU utilization (Load_{Pred(U)}), or the maximum CPU utilization (Load_{Threshold(U)}). In some of these embodiments, overload control is triggered based on a relationship between the predicated value and threshold value such as:

(1) Load_{Pred(R)}≧Load_{Threshold(R)};

(2) Load_{Pred(Q)}≧Load_{Threshold(Q)};

(3) Load_{Pred(U)}≧Load_{Threshold(U)};

(4) (Load_{Pred(R)}≧Load_{Threshold(R)}) or (Load_{Pred(U)}≧Load_{Threshold(U)});

(5) (Load_{Pred(Q)}≧Load_{Threshold(Q)}) or (Load_{Pred(U)}≧Load_{Threshold(U)});

(6) (Load_{Pred(R)}≧Load_{Threshold(R)}) and (Load_{Pred(U)}≧Load_{Threshold(U)}); or

(7) (Load_{Pred(Q)}≧Load_{Threshold(Q)}) and (Load_{Pred(U)}≧Load_{Threshold(U)}).

It should be appreciated that though conventional techniques do not use session rate and message queue length together since they both convey overload information at the application level, an overload control trigger may be based on both session rate and message queue length.

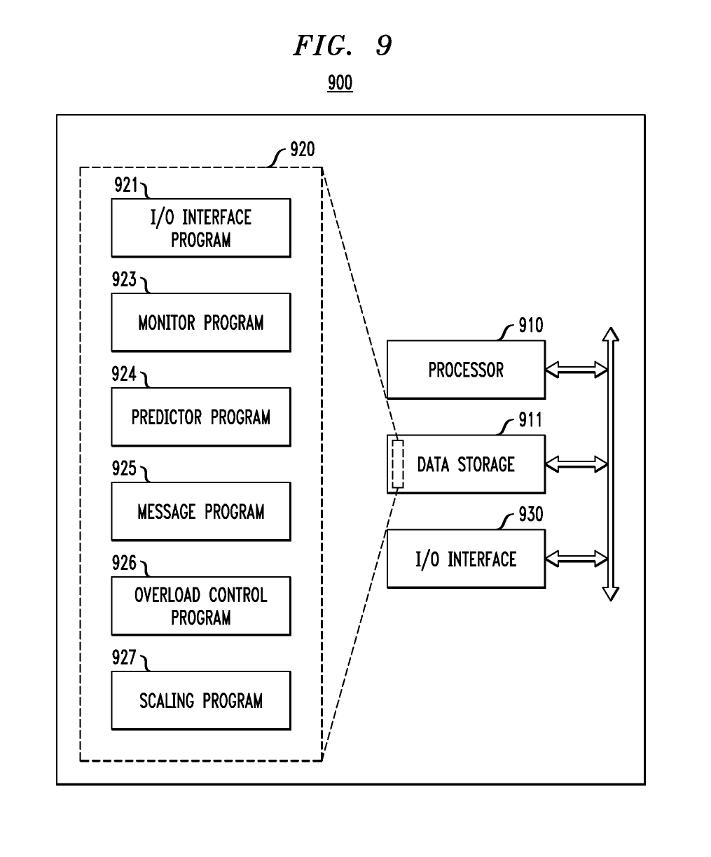

FIG. 8 depicts a flow chart illustrating an embodiment of a method 800 for an RE (e.g., one of SIP servers 130 of FIG. 1, one of SIP servers 330 of FIG. 3 or one of SIP servers 430 of FIG. 4) to trigger a scaling operation. The method starts at step 805 and includes: determining, at the RE, Load_{Pred} (step 810); mapping, at the RE, Load_{Pred} to a predicated resource usage (step 820); triggering, at the RE, a resource scaling decision based on the predicated resource usage (step 840); optionally updating, at the RE, one or more threshold limits based on the triggered scaling decision (step 860); and ending at step 895.

In the method 800, the step 810 includes determining, at the RE, Load_{Pred} as described herein, particularly in the steps of FIG. 5.

In the method 800, the step 820 includes mapping, at the RE, Load_{Pred} to a predicated resource usage. A predicted resource usage may be any suitable resource such as described herein (e.g., servers, processor cores, memory devices, storage devices, networking devices or the like). For purposes of explanation, CPU utilization will be used. Load_{Pred} may be converted to Load_{Pred(U)} as described herein, particularly in the conversion embodiment in step 740 of FIG. 7. For example, using the functions f1 and f2, Load_{Pred} may be converted to Load_{Pred(U)} as follows:
1. Load_{Pred(U}_{_}_{fromR)}=f1(Load_{Pred(R)}); or
2. Load_{Pred(U}_{_}_{fromQ)}=f2(Load_{Pred(Q)}).

In the method 800, the step 840 includes triggering, at the RE, a resource scaling decision based on the predicated resource usage. A resource scaling decision may be any suitable scaling decision such as:
1. When to decrease/increase a resource requirement(s) for the current VM. For example, a decision is made to scale up or down VM one or more resources.
2. When to start a new VM or spin a VM down. For example, once the upper limit for VM resources is either reached or expected to be reached in the next time step.

In particular, the scaling decision is based on the predicted CPU utilization (e.g., Load_{Pred(U)}) and enhanced by using the application level load predictions (e.g., Load_{Pred(U}_{_}_{fromR)} or Load_{Pred(U}_{_}_{fromQ)}). Advantageously, resource scaling decisions are enhanced by using application level load predictions. The enhanced predicted CPU usage (i.e., Load_{Pred(E}_{_}_{U)}) may be based on any suitable method such as:
1. Load_{Pred(E}_{_}_{U)}=c*max(Load_{Pred(U)}, Load_{Pred(U}_{_}_{fromR)}); or
2. Load_{Pred(E}_{_}_{U)}=c*max(Load_{Pred(U)}, Load_{Pred(U}_{_}_{fromQ)}).

Where c>=1 is an optional padding parameter that increases the predicted CPU limit to compensate for under estimation errors.

The scaling decision may be based on any suitable method such as:
1. If the current CPU limit is above Load_{Pred(E}_{_}_{U)}, then the VM reduces the CPU limit (e.g., reduces resources);
2. If the current CPU limit is above Load_{Pred(E}_{_}_{U)}, and the difference between the current CPU limit and Load_{Pred(E}_{_}_{U)} is above a threshold value (e.g., a padding value), then the VM reduces the CPU limit. Advantageously, the use of the threshold value may reduce the number of unnecessary CPU scaling-down operations;
3. If the current CPU limit is below Load_{Pred(E}_{_}_{U)}, then the VM increases the CPU limit. In some embodiments, the CPU limit is increased to Load_{Pred(E}_{_}_{U)} and an optional padding parameter; or
4. If the current CPU limit is below Load_{Pred(E}_{_}_{U)}, and Load_{Pred(E}_{_}_{U)} or Load_{Pred(E}_{_}_{U)} plus the padding parameter is above the CPU limit, then the server starts up a new VM.

The method 800 optionally includes step 860. Step 860 includes updating, at the RE, one or more threshold limits based on the triggered scaling decision. In particular, one or more of the threshold values (e.g., Load_{Threshold(R)}, Load_{Threshold(Q)}, or Load_{Threshold(U)}) are increased based on Load_{Pred(E}_{_}_{U)}.

In some embodiments of the step 860, Load_{Threshold(U)} is updated based on Load_{Pred(E}_{_}_{U)} and application level load metrics such as Load_{Threshold(R)} or Load_{Threshold(Q)} are updated based on the updated value of Load_{Threshold(U)}. Application level load may be changed according to the mapping functions as described herein, particularly in the conversion embodiment in step 740 of FIG. 7. For example, using the functions f1_inverse and f2_inverse, Load_{Threshold(U)} may be converted to Load_{Threshold(R)} or Load_{Threshold(Q)} as follows:
1. Load_{Threshold(R)}=f1_inverse(Load_{Threshold(U)}); or
2. Load_{Threshold(Q)}=f2_inverse(Load_{Threshold(U)}).

It should be appreciated that the overload control mechanisms in method 700 may then operate with updated threshold values Load_{Threshold(U)}, Load_{Threshold(R)} or Load_{Threshold(Q)}. Advantageously, updating the threshold values may allow the server to operate more efficiently or handle more signaling messages.

In some embodiments of the step 840, research scaling decisions are also based on the time duration required to start a new VM. It should be appreciated that the time to start a new VM may be longer than local VM scaling operations.

Although primarily depicted and described in a particular sequence, it should be appreciated that the steps shown in methods 500, 600, 700 and 800 may be performed in any suitable sequence. Moreover, the steps identified by one step may also be performed in one or more other steps in the sequence or common actions of more than one step may be performed only once.

It should be appreciated that steps of various above-described methods can be performed by programmed computers. Herein, some embodiments are also intended to cover program storage devices, e.g., data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable data storage media. The embodiments are also intended to cover computers programmed to perform said steps of the above-described methods.

FIG. 9 schematically illustrates an embodiment of an apparatus 900 such an SE or RE (e.g., one of SIP servers 130 of FIG. 1, one of SIP servers 330 of FIG. 3 or one of SIP servers 430 of FIG. 4). The apparatus 900 includes a processor 910, a data storage 911, and an I/O interface 930.

The processor 910 controls the operation of the apparatus 900. The processor 910 cooperates with the data storage 911.

The data storage 911 stores programs 920 executable by the processor 910. Data storage 911 may also optionally store program data such as threshold values, historical data or the like as appropriate.

The processor-executable programs 920 may include an I/O interface program 921, a monitor program 923, a predictor program 924, a message program 925, an overload control program 926 or a scaling program 927. Processor 910 cooperates with processor-executable programs 920.

The I/O interface 930 cooperates with processor 910 and I/O interface program 921 to support communications over an appropriate one(s) of SIP server communication channels 135 of FIG. 1 as described herein by performing an appropriate one of steps 640 or 650 of FIG. 6 as described above.

The monitor program 923 performs an appropriate one of steps 510 of FIG. 5 or 610 of FIG. 6 as described above.

The predictor program 924 performs one or more of the steps 520, 530, 540, 560, or 580 of FIG. 5, steps 620 or 670 of FIG. 6, step 710 of FIG. 7, or step 810 of FIG. 8 as described above.

The message program 925 performs one or more of the steps 630 or 660 of FIG. 6 as described above.

The overload control program 926 performs one or more of the steps 720 or 740 of FIG. 7 as described above.

The scaling program 927 performs one or more of the steps 820, 840 or 860 of FIG. 8 as described above.

In some embodiments, the processor 910 may include resources such as processors/CPU cores, the I/O interface 930 may include any suitable network interfaces, or the data storage 911 may include memory or storage devices. Moreover the apparatus 900 may be any suitable physical hardware configuration such as: one or more server(s), blades consisting of components such as processor, memory, network interfaces or storage devices. In some of these embodiments, the apparatus 900 may include cloud network resources that are remote from each other.

In some embodiments, the apparatus 900 may be virtual machine. In some of these embodiments, the virtual machine may include components from different machines or be geographically dispersed. For example, the data storage 911 and the processor 910 may be in two different physical machines.

When processor-executable programs 920 are implemented on a processor 910, the program code segments combine with the processor to provide a unique device that operates analogously to specific logic circuits.

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated that any block diagrams herein represent conceptual views of illustrative circuitry embodying the principles of the invention. Similarly, it should be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. An apparatus for providing signaling protocol overload control, the apparatus comprising:
a data storage; and
a processor communicatively connected to the data storage, the processor being configured to:
monitor a local load over one or more time periods;
determine a predicted local load based on the local load;
receive a signaling message from an upstream server;
determine a predicted remote load based on the signaling message, wherein the predicted remote load is associated with an un-throttled load of signaling messages directed from the upstream server to the apparatus; and
determine a predicted load based on the predicted local load and the predicted remote load.

2. The apparatus of claim 1, wherein the signaling message is a SIP message.

3. The apparatus of claim 1, wherein the signaling message comprises a remote load parameter indicating the predicted remote load and a remote load time period parameter indicating a time period associated with the predicted remote load.

4. The apparatus of claim 1, wherein the local load comprises a session load.

5. The apparatus of claim 1, wherein the processor is further configured to:
receive a second signaling message from a second upstream server; and
determine a second predicted remote load based on the second signaling message, wherein the second predicted remote load is associated with an un-throttled second load of signaling messages directed from the second upstream server to the apparatus;
wherein the determination of the predicted load is further based on the second predicted remote load.

6. The apparatus of claim 1, wherein the determination of the predicted load is further based on a trust parameter.

7. The apparatus of claim 6, wherein the trust parameter is based on an historical event.

8. The apparatus of claim 6,
wherein the signaling message comprises a remote load parameter indicating the predicted remote load and a remote load time period parameter indicating a time period associated with the predicted remote load; and
wherein the trust parameter is based on the remote load time period parameter.

9. The apparatus of claim 8,
wherein the remote time period parameter comprises an indication of a measurement start time; and
wherein the trust parameter is further based on a time difference between the measurement start time and a current timestamp of the apparatus.

10. The apparatus of claim 1, wherein the processor is further configured to:
determine a local load threshold; and
trigger an overload control event based on the predicted load and the local load threshold.

11. The apparatus of claim 10, wherein the processor is further configured to:
convert the predicted load to a CPU utilization load.

12. The apparatus of claim 1, wherein the processor is further configured to:
determine a local resource threshold;
mapping the predicted load to a predicted resource usage; and
trigger a scaling operation based on the predicted resource usage and the local resource threshold.

13. The apparatus of claim 12, wherein the processor is further configured to:
update the local resource threshold based on the scaling operation.

14. The apparatus of claim 13, wherein the local resource is an application level load metric.

15. A method for providing signaling protocol overload control, the method comprising:
at a processor communicatively connected to a data storage, monitoring a local load over one or more time periods;
determining, by the processor in cooperation with the data storage, a predicted local load based on the local load;
receiving, by the processor in cooperation with the data storage, a signaling message from an upstream server;
determining, by the processor in cooperation with the data storage, a predicted remote load based on the signaling message, wherein the predicted remote load is associated with an un-throttled load of signaling messages directed from the upstream server to the apparatus; and
determining, by the processor in cooperation with the data storage, a predicted load based on the predicted local load and the predicted remote load.

16. The method of claim 15, wherein the signaling message comprises a remote load parameter indicating the predicted remote load and a remote load time period parameter indicating a time period associated with the predicted remote load.

17. The method of claim 15, wherein the method further comprises:
receiving, by the processor in cooperation with the data storage, a second signaling message from a second upstream server; and
determining, by the processor in cooperation with the data storage, a second predicted remote load based on the second signaling message, wherein the second predicted remote load is associated with an un-throttled second load of signaling messages directed from the second upstream server to the apparatus;
wherein determining the predicted load is further based on the second predicted remote load.

18. The method of claim 15, wherein the determination of the predicted load is further based on a trust parameter; and wherein the trust parameter is based on an historical event.

19. The method of claim 15,
wherein the signaling message comprises a remote load parameter indicating the predicted remote load and a remote load time period parameter indicating a time period associated with the predicted remote load;
wherein the trust parameter is based on the remote load time period parameter;
wherein the remote time period parameter comprises an indication of a measurement start time; and
wherein the trust parameter is further based on a time difference between the measurement start time and a current timestamp of the apparatus.

20. The method of claim 15, wherein the method further comprises:
determining, by the processor in cooperation with the data storage, a local load threshold;
triggering, by the processor in cooperation with the data storage, an overload control event based on the predicted load and the local load threshold; and
converting, by the processor in cooperation with the data storage, the predicted load to a CPU utilization load.

21. The method of claim 15, wherein the method further comprises:
determining, by the processor in cooperation with the data storage, a local resource threshold;
mapping, by the processor in cooperation with the data storage, the predicted load to a predicted resource usage;
triggering, by the processor in cooperation with the data storage, a scaling operation based on the predicted resource usage and the local resource threshold; and
updating, by the processor in cooperation with the data storage, the local resource threshold based on the scaling operation.

22. A non-transitory computer-readable storage medium storing instructions which, when executed by a computer, cause the computer to perform a method, the method comprising:
monitoring a local load over one or more time periods;
determining a predicted local load based on the local load;
receiving a signaling message from an upstream server;
determining a predicted remote load based on the signaling message, wherein the predicted remote load is associated with an un-throttled load of signaling messages directed from the upstream server to the apparatus; and
determining a predicted load based on the predicted local load and the predicted remote load.
